(19) United States
(12) Patent Application Publication
(10) Pub. No.: US 2007/0040810 A1
(43) Pub. Date: Feb. 22, 2007

(54) Touch controlled display device

(75) Inventors: David R. Dowe, Holley, NY (US); David J. Cornell, Scottsville, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/206,589

(22) Filed: Aug. 18, 2005

(51) Int. Cl. G09G 5/00

(52) U.S. Cl. 345/173

(57) ABSTRACT

In one aspect of the invention, a display device is provided. The display device comprises a body having an opening to a display receiving area. A display is joined to the display receiving area and a generally transparent contact element positioned between the opening and the display. At least two force sensitive elements are between the contact element and the display receiving area, and each force sensitive element is adapted to generate a signal when a force has been applied to the contact element. A controller receives the signals and determines a user input action based upon the signals received. The force sensitive elements are adapted to detect the application of force along different axes and to generate signals that the controller can use to determine when a force has been applied to the contact element and along which of the different axes the force has been applied.

### FIELD OF THE INVENTION

This invention relates to display devices, in particular to methods and user input systems for use in display devices.

### BACKGROUND OF THE INVENTION

Display devices, including but not limited to, digital still cameras, video cameras, cellular telephones and the like conventionally use displays in a fixed position within a device body. Alternatively, it is known to provide displays that are fixed within a housing of a type that is joined to but movable relative to a body of a display device such as is done with some types of video cameras. A user of such a display device controls the device by way of external user input controls such as buttons, joysticks, dials, wheels, jog dials and the like. Such user input controls are placed around the periphery of the display or on other surfaces of the display device, such as on front, top, bottom, back or sides. These controls occupy a certain amount of surface area on the display device thus, the overall size of a display device is in part determined by the size of the display and by the number of independent external controls used to operate the display device.

For example, FIG. 1 shows a prior art display device 10 in the form of a digital camera 12. In the camera of FIG. 1, a display 14 is fixedly positioned on a housing 16. External controls 20 that are on housing 16 are used to control the operation of digital camera 12. External controls 20 include an on/off button 22, a menu button 24, a select button 26, a share button 28 and a navigation button 30. To activate digital camera 12, a user presses on/off button 22. To compose a digital picture, the user looks through a viewfinder 32, or where digital camera 12 uses display 14 to provide a virtual viewfinder, the user views images of the scene that are presented on display 14. When the scene is properly composed, a user indicates a desire to capture an image by depressing shutter trigger button 34. To use certain functions of digital camera 12 that do not have dedicated buttons, the user depresses menu button 24. In response, display 14 presents a menu of several optional functions such as reviewing pictures already taken, deleting a particular picture, etcetera. The user navigates the menu by use of navigation button 30. For example, the menu presented to the user can be a vertical list of functions, and the user presses navigation button 30 toward up arrow 13 or down arrow 15 until the desired function was highlighted on the display. Selection of the desired function is then made by depressing the select button 26.

For selecting certain previously captured pictures for review, menu button 24, navigation button 30, and select button 26 can be used to select a review function from the menu. When the review function has been selected, navigation through the pictures is accomplished by pressing navigation button 30 to the right or left towards arrows 17 and/or 19 respectively.

As the technology used in display devices becomes more capable and as displays become less expensive, there is a desire to offer display devices with larger displays. There is also a concomitant desire to provide display devices that offer a greater range of features which in turn demands a greater variety and/or number of controls. As a result of these influences, many display devices are becoming proportionately larger. However, there is also a desire for such devices to become smaller and lighter so as to provide portability and convenience advantages. These competing desires have caused display devices to be developed that devote more of the external surface area of a display device for the display and that therefore have a smaller proportion of external surface area of the display device available for use in locating the controls. Accordingly, fewer controls are being incorporated in display devices with the controls being used for multiple, often unrelated, purposes such as where different controls are used for different purposes in different modes of operation. This however, is confusing to many users.

Another solution to this problem is to use a special type of display having a touch screen. A touch screen display has special transparent surface that can sense when a finger or stylus contacts the surface and can provide control signals that can be used to control device functions. Several types of touch screens are available such as resistive touch screens having a matrix of resistors that change resistance when touched, and capacitive touch screen having a matrix of capacitors that change capacitance when touched.

FIG. 2 illustrates a prior art digital camera 12 in which a touch screen display 36 is provided. In FIG. 2, touch screen display 36 is fixedly positioned on a housing 16 of digital camera 12. Control of this prior art digital camera 12 is effected by using a combination of external controls 20 and touch screen display 36. The example digital camera 12 illustrated in FIG. 2 has external controls 20 that include on/off button 22 and menu button 24. Other control inputs are made by way of touch screen display 36 which, in this example, comprises a transparent sheet that is positioned on the face of touch screen display 36 that can be used to sense changes in the capacitance that occurs when a finger or stylus touches a portion of the screen.

On/off button 22 is present to activate the prior art digital camera 12 of FIG. 2. To compose a digital picture, the user looks through viewfinder 32, or views the scene on touch screen display 36. To take a picture, the user depresses shutter trigger button 34. To use specific functions of digital camera 12 that cannot be accessed conveniently using external controls 20, the user depresses menu button 24. Touch screen display 36 then presents a menu 38 of several functions such as reviewing pictures already taken, deleting a particular picture, etcetera. Menu 38 is such that certain functional areas 40-46 of touch screen display 36 are referenced to particular functions and graphics related to those functions are shown in specific functional areas 40-46 of touch screen display 36. The user can navigate menu 38 by pressing a finger or stylus against touch screen display 36 in one of functional areas 40-46. For example, in FIG. 2, menu 38 is presented to the user in the form of a two-dimensional matrix of functions and the user can press their finger on the portion of touch screen display 36 associated with a desired function to select that function. The function is then executed or a subset of functions can be displayed for further selection.

For reviewing pictures already taken with the prior art digital camera 12 of FIG. 2, menu button 24, is depressed as described above. The user can then press a functional area of touch screen display 36 associated with a review pictures function. Navigation through the pictures to be reviewed is then accomplished by pressing forward or reverse arrow functional areas (not shown) that can be presented on touch screen display 36.

Thus, touch screen displays 36 save space on a display device by reducing the number of external display controls thereby allowing a touch screen display 36 to occupy a greater proportion of the exterior surface of a display device. However, there are some disadvantages for using touch screen display 36 in a display device. For example, the cost of touch screen display 36 is comparatively high for many display devices and such touch screens are often vulnerable to damage from incidental contact causing such a display to wear and fail well before the useful life of the digital camera 12 or other display device in which the display is mounted has expired. Further, repeated finger contact with the touch screen can leave an unattractive pattern of fingerprints on the display which can be difficult to clean without risking damage to the touch screen display 36. Finally, many such screens are particularly vulnerable to damage electronic discharge and other environmental contaminates.

Accordingly, what is desired is a way to use the portion of an external surface of a display device to sense user input actions and to generate signals in response thereto for control of the display device so that the number of controls external to the display can be minimized while still providing a convenient user input scheme with a robust interface in a low cost design.

### SUMMARY OF THE INVENTION

In one aspect of the invention, a display device is provided. The display device comprises a body having an opening to a display receiving area; a display joined to the body within the display receiving area; and a generally transparent contact element positioned between the opening and the display so that at least a part of an image presented by the display is viewed through the contact element. At least two force sensitive elements are between the contact element and the display receiving area, and each force sensitive element is adapted to generate a signal when a force has been applied to the contact element. A controller receives the signals and determines a user input action based upon the signals received. The force sensitive elements are adapted to detect the application of force along different axes and to generate signals that the controller can use to determine when a force has been applied to the contact element and along which of the different axes the force has been applied.

In another aspect of the invention, a display device comprises a body having a display area with a display therein, a generally transparent contact element joined to the body for movement between a neutral position and two separate force applied positions into which the contact element can be moved within the display receiving area when a force is applied and arrayed so that images presented by the display to viewed therethrough. A plurality of force sensitive elements is between the contact element and the display receiving area. Each force sensitive element is adapted to sense movement of the contact element into either of the force applied positions; and a controller to determine a user input action based upon the force applied to the force sensitive elements by the contact element. Wherein movement of the contact element into one of two separate force applied positions require movement of the contact element along a different axis than movement of the display into the other one of two force applied positions.

In yet another aspect of the invention, a display device comprises a body having a display receiving area; a display joined to the body within the display receiving area; a plurality of force sensing elements positioned in the display receiving area in association with the display so as to sense the application of force to the display along at least two separated axes; and a controller to determine a user input action based upon sensed application of force of the display.

In still another aspect of the invention, a method is provided for operating a display device having a contact element positioned within a display receiving area on a body. In accordance with the method, the application of force by the contact element against structures holding the contact element to the display receiving area at least along two different possible axes of movement and determining a user input action based upon a sensed application of force to the contact element.

### BRIEF DESCRIPTION OF THE DRAWINGS

FIG. 1 is a rear perspective view of a prior art digital camera that utilizes a display on the camera back;

FIG. 2 is a rear perspective view of a prior art digital camera that utilizes a touch sensitive screen on the surface of the attached display;

FIG. 3 is a block diagram showing one embodiment of a display device of the invention;

FIG. 4 shows a top, back, right side perspective view showing an exterior view of one possible embodiment of the display device of FIG. 3;

FIG. 5 is a rear view of the embodiment of FIGS. 3 and 4 depicting a scene that a user views by way of the display;

FIG. 6 illustrates the same view as illustrated in FIG. 5, but also shows, in phantom, the placement of force sensitive elements;

FIG. 7 is a cross-section view of FIG. 6;

FIG. 8 is a back view of the display device of FIGS. 3-7 used to select a mode of operation;

FIG. 9 is a back view of the display device of FIGS. 3-7 used in a zoom selection setting;

FIG. 10 is a back view of the display device of FIGS. 3-7 during a selection of a mode of operation;

FIGS. 11-14 illustrate another embodiment of the display device;

FIGS. 15 and 16 illustrate another embodiment of the display device; and

FIGS. 17-18 illustrate another embodiment of the display device; and

FIGS. 19-20 illustrate another embodiment of the display device.

### DETAILED DESCRIPTION OF THE INVENTION

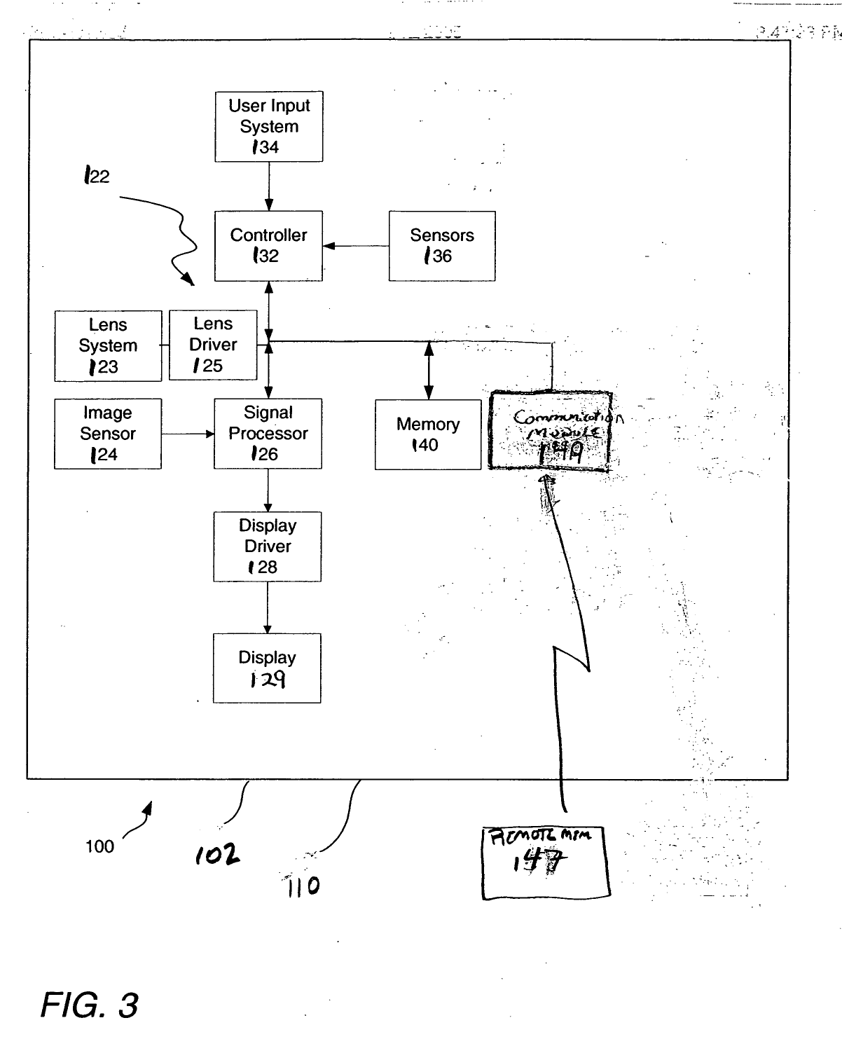

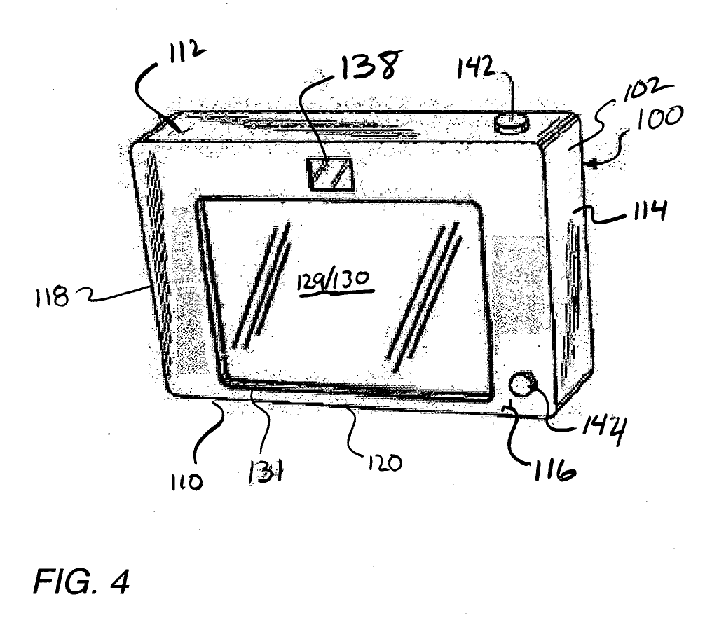

FIG. 3 shows a block diagram of one embodiment of a display device 100 comprising a digital camera 102. FIG. 4 shows a top, back, right side perspective view of the display device 100 of FIG. 3. As is shown in FIGS. 3 and 4, display device 100 comprises a body 110 with a top side 112, a right side 114, a back side 116, a left side 118 and a bottom 120 containing an optional image capture system 122, having a lens system 123, an image sensor 124, a signal processor 126, an optional display driver 128 and a display 129. In operation, light from a scene is focused by lens system 123 to form an image on image sensor 124. Lens system 123 can have one or more elements. Lens system 123 can be of a fixed focus type or can be manually or automatically adjustable. Lens system 123 optionally uses a lens driver 125 having, for example, a motor arrangement to automatically move lens elements to provide variable zoom or focus. Other known arrangements can be used for lens system 123.

Light from the scene that is focused by lens system 123 onto image sensor 124 is converted into image signals representing an image of the scene. Image sensor 124 can comprise a charge couple device (CCD), a complimentary metal oxide semiconductor (CMOS) sensor, or any other electronic image sensor known to those of ordinary skill in the art. The image signals can be in digital or analog form.

Signal processor 126 receives the image signals from image sensor 124 and transforms each image signal into a digital image in the form of digital data. In the embodiment illustrated, signal processor 126 has an analog to digital conversion capability. Alternatively, a separate analog to digital converter (not shown) can be positioned between image sensor 124 and signal processor 126 to convert image signals into a digital form. In this latter embodiment, signal processor 126 can comprise a digital signal processor adapted to convert the digital data from such an analog to digital converter into a digital image. The digital image can comprise one or more still images, multiple still images and/or a stream of apparently moving images such as a video segment. Where the digital image data comprises a stream of apparently moving images, the digital image data can comprise image data stored in an interleaved or interlaced image form, a sequence of still images, and/or other forms known to those of skill in the art of digital video. Signal processor 126 can apply various image processing algorithms to the image signals when forming a digital image. These can include, but are not limited to, color and exposure balancing, interpolation and compression.

A controller 132 controls the operation of display device 100, including, but not limited to, image capture system 122, display 129 and a memory 140 during imaging operations. Controller 132 causes image sensor 124, optional lens driver 125, signal processor 126, display 129 and memory 140 to capture, process, store and/or display images in response to signals received from a user input system 134, data from signal processor 126 and data received from optional sensors 136 and/or signals received from a communication module 149. Controller 132 can comprise a microprocessor such as a programmable general-purpose microprocessor, a dedicated microprocessor or micro-controller, an arrangement of discrete elements, or any other system that can be used to control operation of display device 100.

Controller 132 cooperates with user input system 134 to allow display device 100 to interact with a user. User input system 134 can comprise any form of transducer or other device capable of receiving an input from a user and converting this input into a form that can be used by controller 132 in operating display device 100. For example, user input system 134 can comprise controls such as a touch screen input, a touch pad input, a 4-way switch, a 6-way switch, an 8-way switch, a stylus system, a trackball system, a joystick system, a voice recognition system, a gesture recognition system or other such systems.

In the embodiment shown in FIGS. 3 and 4, user input system 134 includes a capture button 142 that sends a trigger signal to controller 132 indicating a desire to capture an image, and an on/off switch 144. When a user wishes to take a picture using camera 102, the user presses on/off switch 144 which sends a signal activating controller 132. The user then can frame the scene to be photographed through either an optical viewfinder system 138, or by viewing images of the scene displayed on display 129. When the scene to be photographed is framed to the user's liking the user can then press capture button 142 to cause an image to be captured.

Sensors 136 are optional and can include light sensors, position sensors and other sensors known in the art that can be used to detect conditions in the environment surrounding display device 100 and to convert this information into a form that can be used by controller 132 in governing operation of display device 100. Sensors 136 can include, for example, a range finder of the type that can be used to detect conditions in a scene such as distance to subject. Sensors 136 can also include biometric sensors adapted to detect characteristics of a user for security and affective imaging purposes.

Controller 132 causes an image signal and corresponding digital image to be formed when a trigger condition is detected. Typically, the trigger condition occurs when a user depresses capture button 142 however, controller 132 can determine that a trigger condition exists at a particular time, or at a particular time after capture button 142 is depressed. Alternatively, controller 132 can determine that a trigger condition exists when optional sensors 136 detect certain environmental conditions such as a pulse of infra red light.

Controller 132 can also be used to generate metadata in association with each image. Metadata is data that is related to a digital image or a portion of a digital image but that is not necessarily observable in the image data itself. In this regard, controller 132 can receive signals from signal processor 126, camera user input system 134, and other sensors 136 and, optionally, generates metadata based upon such signals. The metadata can include but is not limited to information such as the time, date and location that the image was captured, the type of image sensor 124, mode setting information, integration time information, taking lens unit setting information that characterizes the process used to capture the archival image and processes, methods and algorithms used by display device 100 to form the archival image. The metadata can also include but is not limited to any other information determined by controller 132 or stored in any memory in display device 100 such as information that identifies display device 100, and/or instructions for rendering or otherwise processing the digital image with which the metadata is associated. The metadata can also comprise an instruction to incorporate a particular message into a digital image when presented. Such a message can be a text message to be rendered when the digital image is presented or rendered. The metadata can also include audio signals. The metadata can further include digital image data. The metadata can also include any other information entered into display device 100. Controller 132 will also typically be adapted to use, process, edit and store metadata that is provided with images that are not captured by display device 100.

Digital images and optional metadata can be stored in a compressed form. For example, where the digital image comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Pictures Export Group) or Apple Quicktime™ standard can be used to store digital images that are in a video form. Other image compression and storage forms can be used.

The digital images and metadata can be stored in a memory such as memory 140. Memory 140 can include conventional memory devices including solid state, magnetic, optical or other data storage devices. Memory 140 can be fixed within display device 100 or it can be removable. The digital images and metadata can also be stored in a remote memory system 147 that is external to display device 100 such as a personal computer, computer network or other imaging system.

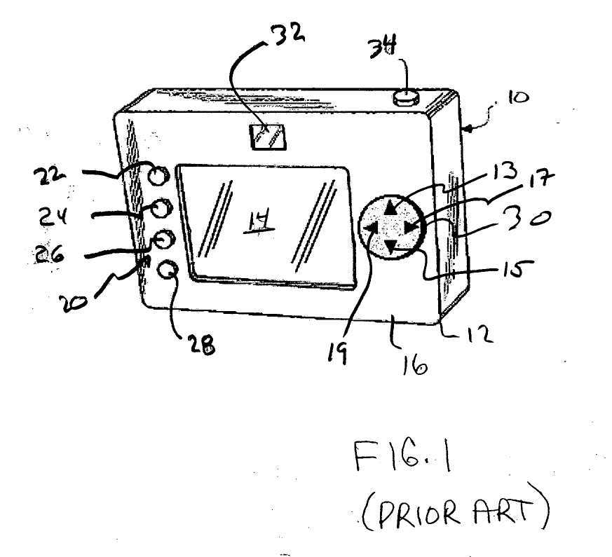

In the embodiment shown in FIGS. 3 and 4, display device 100 has a communication module 149 for communicating with the remote memory system. Communication module 149 can be for example, an optical, radio frequency or other transducer that converts image and other data into a form that can be conveyed to the remote imaging system by way of an optical signal, radio frequency signal or other form of signal. Communication module 149 can also be used to receive a digital image and other information from a host computer or network (not shown). Controller 132 can also receive information and instructions from signals received by communication module 149 including but not limited to, signals from a remote control device (not shown) such as a remote trigger button (not shown) and can operate display device 100 in accordance with such signals. Communication module 149 can be an integral component of display device 100 as illustrated in FIG. 1 or it can be a component that is attached thereto such as a card that can be inserted into the display device to enable communications. One example of such a card is the Kodak WI-FI card that enables communication using an Institute of Electrical and Electronic Engineers 802.11(b) standard and that is sold by Eastman Kodak Company, Rochester, N.Y., USA.

Signal processor 126 optionally also uses images signals or the digital images to form evaluation images which have an appearance that corresponds to captured image data and are adapted for presentation on display 129. This allows users of display device 100 to observe digital images that are available in display device 100. For example, images that have been captured by image capture system 122, that are otherwise stored in a memory, such as memory 140, or that are received by way of communication module 149. Display 129 can comprise, for example, a color liquid crystal display (LCD), organic light emitting display (OLED) also known as an organic electroluminescent display (OELD) or other type of video display.

Signal processor 126 and controller 132 also cooperate to generate other images such as text, graphics, icons and other information for presentation on display 129 that can allow interactive communication between controller 132 and a user of display device 100, with display 129 providing information to the user of display device 100 and the user of display device 100 using user input system 134 to interactively provide information to display device 100. Display device 100 can also have other displays such as a segmented LCD or LED display (not shown) which can also permit signal processor 126 and/or controller 132 to provide information to a user. This capability is used for a variety of purposes such as establishing modes of operation, entering control settings, user preferences, and providing warnings and instructions to a user of display device 100. Other systems such as known systems and actuators for generating audio signals, vibrations, haptic feedback and other forms of signals can also be incorporated into display device 100 for use in providing information, feedback and warnings to the user of display device 100.

Typically, display 129 has less imaging resolution than image sensor 124. Accordingly, signal processor 126 reduces the resolution of image signal or digital image when forming evaluation images adapted for presentation on display 129. Down sampling and other conventional techniques for reducing the overall imaging resolution can be used. For example, resampling techniques such as are described in commonly assigned U.S. Pat. No. 5,164,831 “Electronic Still Camera Providing Multi-Format Storage Of Full And Reduced Resolution Images” filed by Kuchta et al., on Mar. 15, 1990, can be used. The evaluation images can optionally be stored in a memory such as memory 140. The evaluation images can be adapted to be provided to an optional display driver 128 that can be used to drive display 129. Alternatively, the evaluation images can be converted into signals that can be transmitted by signal processor 126 in a form that directly causes display 129 to present the evaluation images. Where this is done, display driver 128 can be omitted.

Display device 100 captures digital images using image sensor 124 and other components of image capture system described above. Imaging operations that can be used to capture digital images include a capture process and can optionally also include a composition process and a verification process.

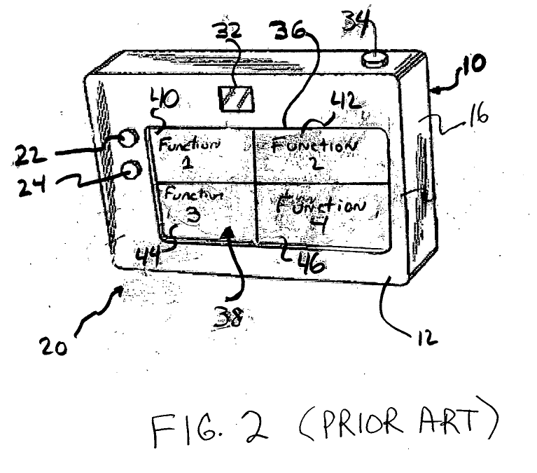

During the optional composition process, controller 132 causes signal processor 126 to cooperate with image sensor 124 to capture digital images and present a corresponding evaluation images on display 129. In the embodiment shown in FIGS. 1 and 2, controller 132 enters the image composition phase when capture button 142 is moved to a half depression position. However, other methods for determining when to enter a composition phase can be used. Images presented during composition can help a user to compose the scene for the capture of digital images.

The capture process is executed in response to controller 132 determining that a trigger condition exists. In the embodiment of FIGS. 1 and 2, a trigger signal is generated when capture button 142 is moved to a full depression condition and controller 132 determines that a trigger condition exists when controller 132 detects the trigger signal. During the capture process, controller 132 sends a capture signal causing signal processor 126 to obtain image signals from image sensor 124 and to process the image signals to form digital image data comprising a digital image. An evaluation image corresponding to the digital image is optionally formed for presentation on display 129 by signal processor 126 based upon the image signal. In one alternative embodiment, signal processor 126 converts each image signal into a digital image and then derives the evaluation image from the digital image.

During the verification process, the corresponding evaluation image is supplied to display 129 and is presented for a period of time. This permits a user to verify that the digital image has a preferred appearance.

Digital images can also be received by display device 100 in ways other than image capture. For example, digital images can by conveyed to display device 100 when such images are recorded on a removable memory. Alternatively digital images can be received by way of communication module 149. For example, where communication module 149 is adapted to communicate by way of a cellular telephone network, communication module 149 can be associated with a cellular telephone number or other identifying number that for example another user of the cellular telephone network such as the user of a telephone equipped with a digital camera can use to establish a communication link with display device 100 and transmit images which can be received by communication module 149. Accordingly, there are a variety of ways in which display device 100 can receive images and therefore it is not essential that display device 100 have an image capture system so long as other means such as those described above are available for importing images into display device 100.

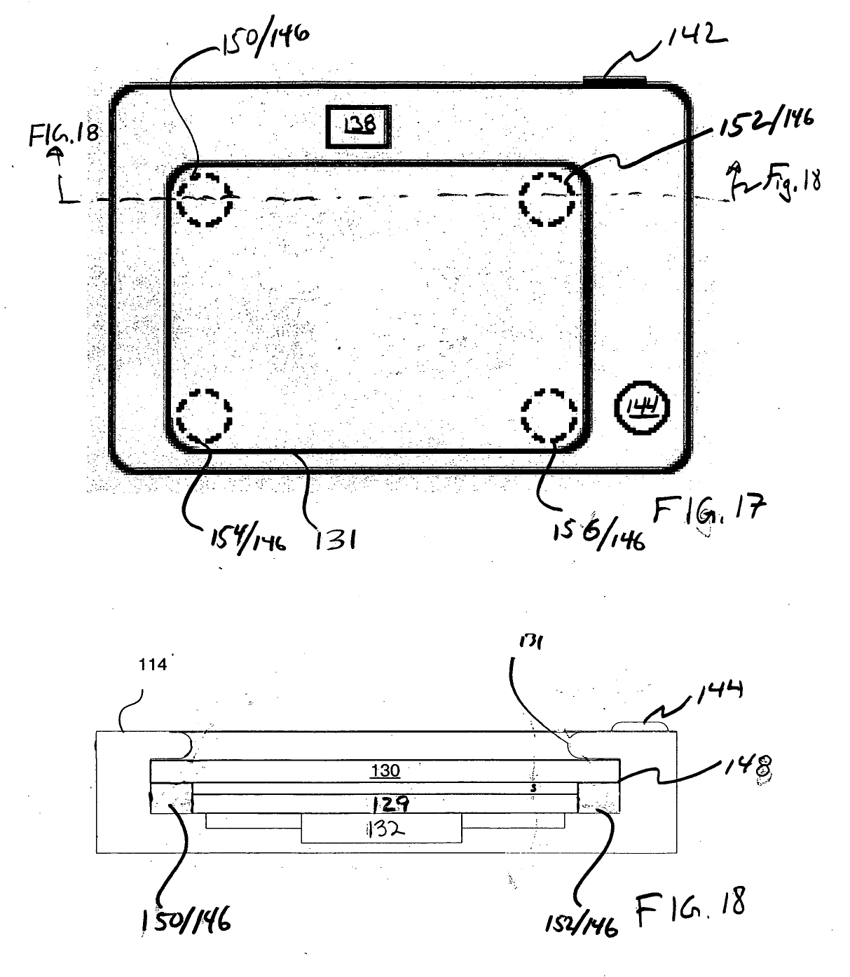

In the embodiment of FIGS. 3 and 4 user input system 134 also comprises a contact element 130 positioned proximate to an opening 131 at the back side 116 of body 110. Contact element 130 comprises any structure that can allow light from display 129 to be observed and that can receive a force applied by a user and can convey at least a portion of such a force to other structures. In the embodiments to be discussed with reference to FIGS. 3-16, contact element 130 comprises at least a part of display 129 and in the embodiments of FIGS. 17-20 contact element 130 comprises a separate structure through which images presented by display 129 can be viewed. Contact element 130 can be rigid, semi-rigid or flexible.

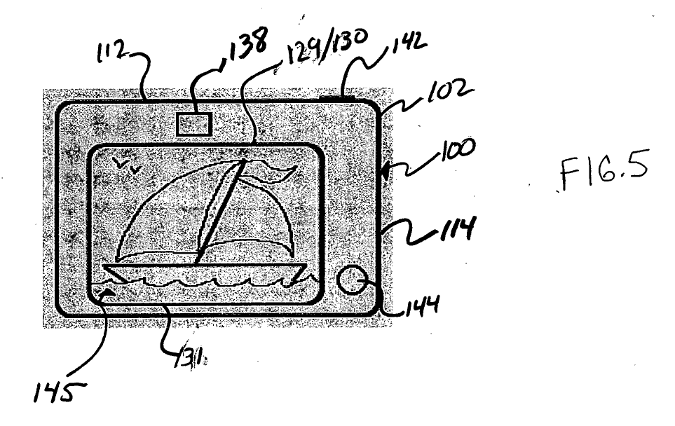

FIG. 5 is a rear view of camera 102 shown in FIG. 4 and depicts an image 145 of the scene that the user is viewing with the intent of taking a picture or is reviewing, having already taken the picture.

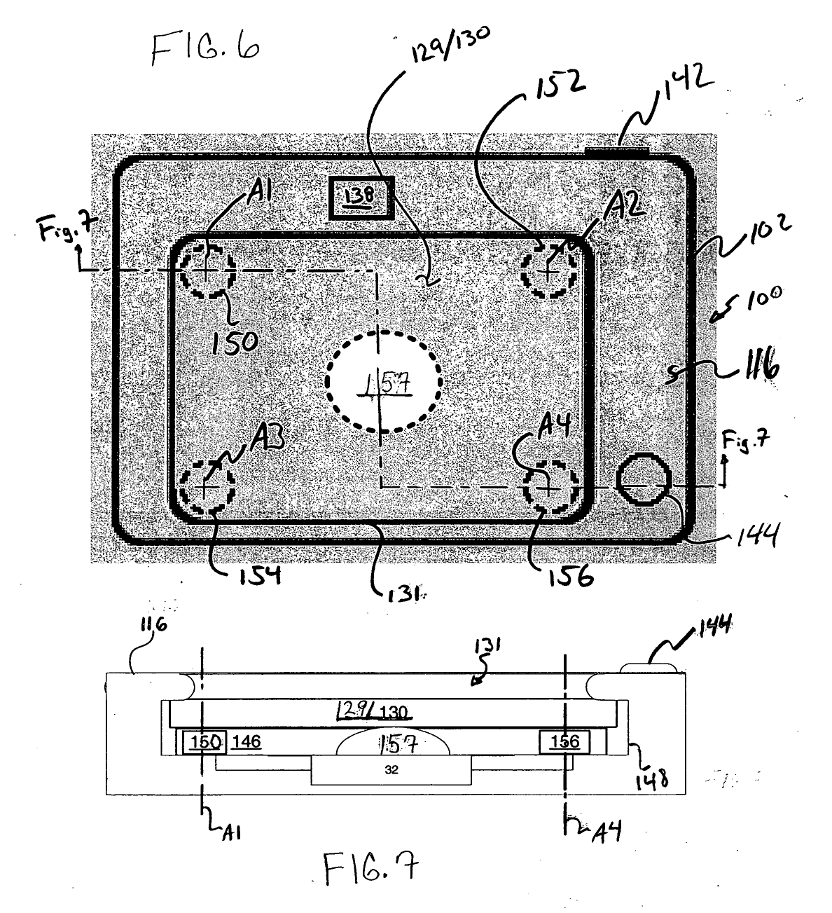

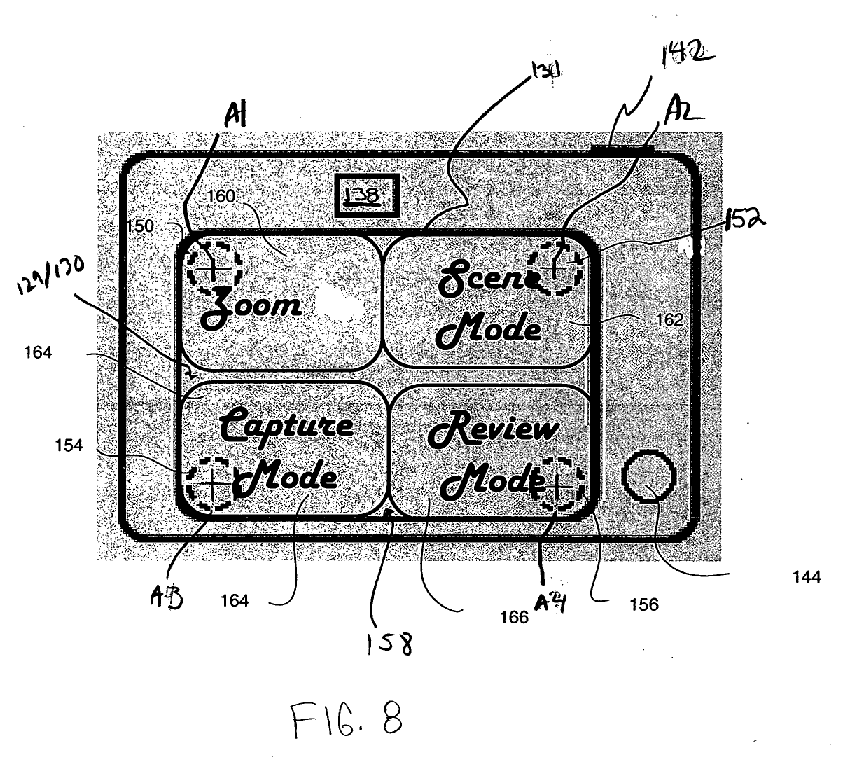

FIG. 6 illustrates the same view of the display device of FIGS. 3-5, but shows, in phantom, force sensitive elements 150, 152, 154, and 156, placed below display 129, while FIG. 7 shows a section view of the embodiment of FIG. 6. As shown in FIGS. 6 and 7, contact element 130 comprises display 129 that rests on a resilient linkage 146. Resilient linkage 146 allows display 129 to move within a range of positions within display receiving area 148.

Also shown in FIG. 6 are an arrangement of force sensitive elements 150, 152, 154 and 156 that join display 129 to display receiving area 148. Force sensitive elements 150, 152, 154 and 156 are not necessarily viewable by the user and are shown in phantom in FIG. 6. Force sensitive elements 150, 152, 154 and 156 are each adapted to sense the application of force. In this embodiment, each force sensitive element 150, 152, 154, 156 senses when a force is applied along an axis shown as axes A1, A2, A3, and A4 in FIGS. 6 and 7.

Force sensitive elements 150, 152, 154 and 156 can be pushbutton switches or can comprise any structure or assembly that can sense the application force thereto and that can generate a signal or that can cause a detectable signal to be generated. A variety of exemplary embodiments force sensitive elements are discussed hereinafter, however, force sensitive elements usable with this invention are not limited to these exemplary embodiments.

When the user wishes to access a camera function other than taking a picture, the user can press on display 129 over one or more of force sensitive elements 150, 152, 154, 156. For instance, to access a main menu, the user can press display 129 in the center applying a downward force along each of axes A1, A2, A3, and A4 causing all four force sensitive elements 150-156 to be depressed at the same time. Controller 132 will recognize that the depression of all four force sensitive elements 150-156 at once is a signal that a main menu is to be displayed.

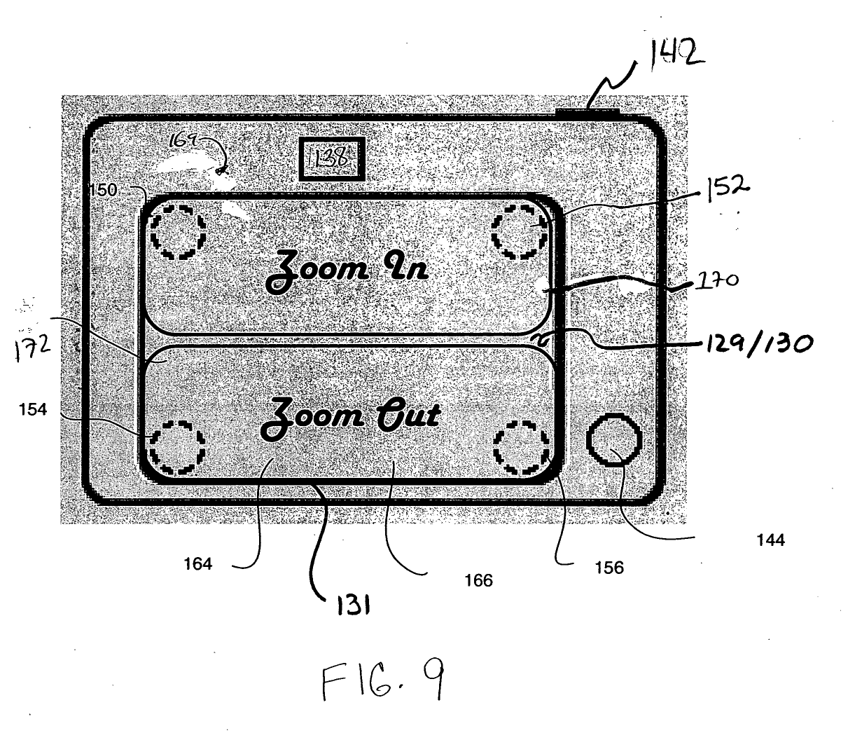

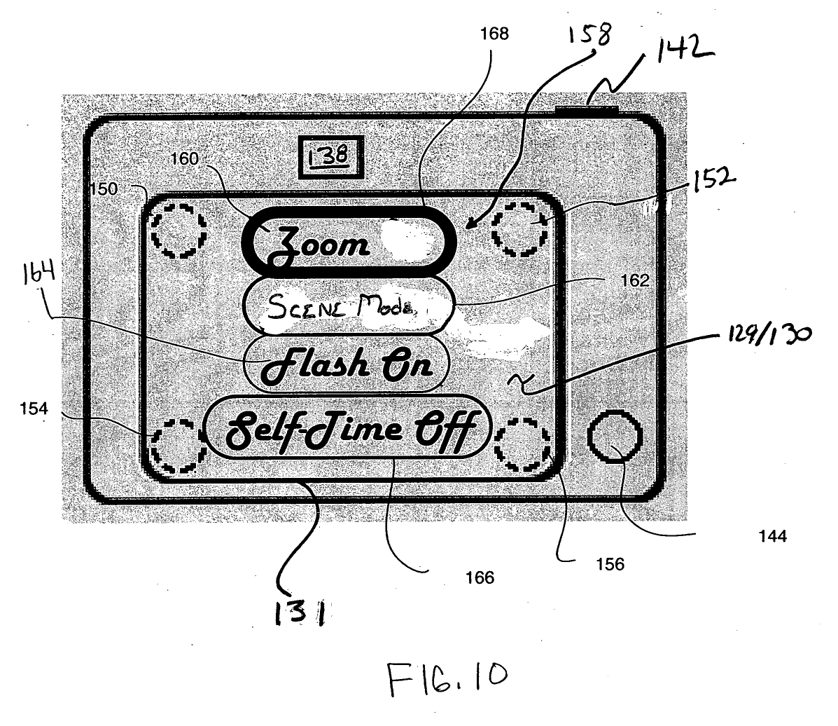

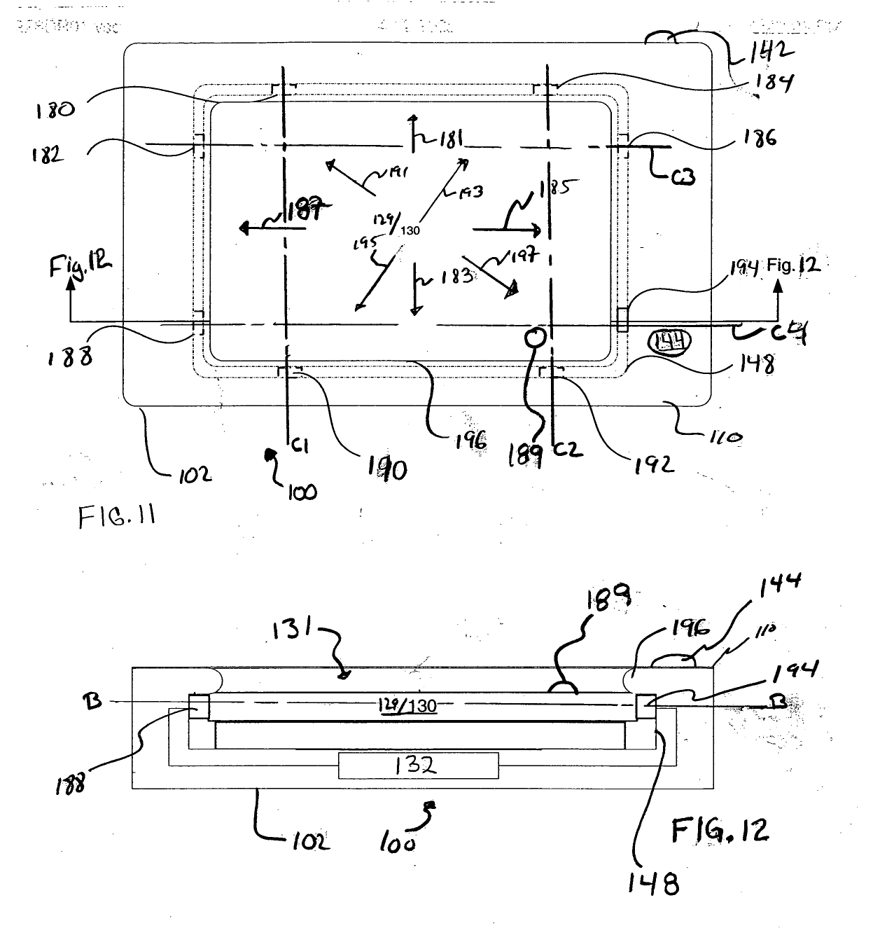

FIG. 8 shows an example of a main menu 158 displayed having functional areas including a zoom adjust function area 160, a scene mode function area 162, a capture mode function area 164, and a review mode function area 166. To change the zoom magnification of the image capture system, the user can press display 129 toward zoom adjust function area 160, along an axis A1 which in turn depresses force sensitive element 150, which sends a signal to controller 132 causing controller 132 to change to another screen display as shown in FIG. 9. Alternatively, as shown in FIG. 10, main menu 158 is vertically arranged so the user could press on the top edge or bottom edge of display 129, to depress the upper two force sensitive elements 150 and 152, or lower two force sensitive elements 154 and 156 associated in those areas to cause a highlighting cursor 168 to move up or down respectively. Alternately, highlighting cursor 168 could be moved up or down by pressing on the top right corner or bottom right corner of display 129 respectively, and thus depressing force sensitive elements 152 and 156 in those areas. Once the zoom function is highlighted, the user can select it by depressing display 129 so that all four force sensitive elements 150, 152, 154, 156 are depressed simultaneously.

After the zoom function is selected, zoom control menu 169 shown in FIG. 9 is displayed having a zoom increase function area 170 and a zoom decrease function area 172. Zoom adjustment can now be performed by pressing on an upper or lower portion of display 129 and thus depressing one or more of force sensitive elements 150, 152, 154 or 156. To zoom out, the user can press on the lower portion of display 129, thus depressing one or more of force sensitive elements 154 and 156. To zoom in, the used can press an upper portion of display 129, thus depressing either or both of force sensitive elements 150 and 152.

For reviewing pictures already taken, a user of camera 102 can return to main menu 158 and select a review function using by pressing on another portion of display 129. The user can then navigate through the pictures by pressing the right and left sides of display 129 or by otherwise pressing particular portions of display 129.

After the desired functions have been selected, the user can return to main menu 158 by executing one or more of pre-programmed depressions of display 129. Once main menu 158 is displayed, the user could selectively press on display 129 toward force sensitive element 154, causing force sensitive element 154 to send a signal to controller 132 causing controller 132 to enter an image capture mode.

To prevent erroneous readings of depressions of force sensitive elements 152, 154, 156, and 158, controller 132 can be adapted to recognize, as a control signal, only those sensed depressions that last continuously for at least a minimum amount of time, such as for example, between 2 and 300 milliseconds. Alternatively, controller 132 can require a predetermined amount of force to be applied to each force sensitive element. Further, a time delay could be incorporated into the control program to read if only one switch had been depressed or that more than one switch had been depressed. This time delay may be, for example, only a few milliseconds or several hundred milliseconds and is determined by the designers.

In the embodiments illustrated, a resilient linkage 146 is shown as a layer of resiliently deformable material such as a sponge rubber material. Resilient linkage 146 helps a contact element 130, such as display 129, return to a level or other default orientation after force has been applied. Resilient linkage 146 can comprise a sponge rubber material that covers the entire area underneath display 129 except where force sensitive elements and fulcrum, if used, are positioned. The sponge rubber material can be adhered to display receiving area 148 and also to display 129.

Alternatively, resilient linkage 146 can be made of some type of resilient material other than sponge rubber, such as an elastomer. Other structures for attaching a contact element 130, such as display 129, to display device 100 can be used so long as resilient linkage 146 continues to offer a resilient response to pressure that is applied to display 129. For example, in one embodiment, resilient linkage 146 can be provided by a combination of a movable support such as a pivot (not shown) that allows display 129 to move within a range of position, and force sensitive elements 150, 152, 154 and 156 that are adapted to resiliently bias display 129 from positions within the range to a neutral position after an applied force moves display 129 to other positions within the range.

Returning now to FIGS. 6 and 7, an optional fulcrum 157 is shown placed under display 129 at the center. Fulcrum 157 aids by providing a more positive tactile experience for the user as the user adjusts display 129 to determine desired camera functions. Fulcrum 157 can take a variety of other forms including a layer of resilient material, a ball/socket connection or any of a wide range of possible mechanical connections. In the various embodiments, care will be taken in the selection of the fulcrum 157 to ensure when a force is applied to display 129, the force will be managed so that the applied force does not damage to display 129 or force sensitive elements 150-156.

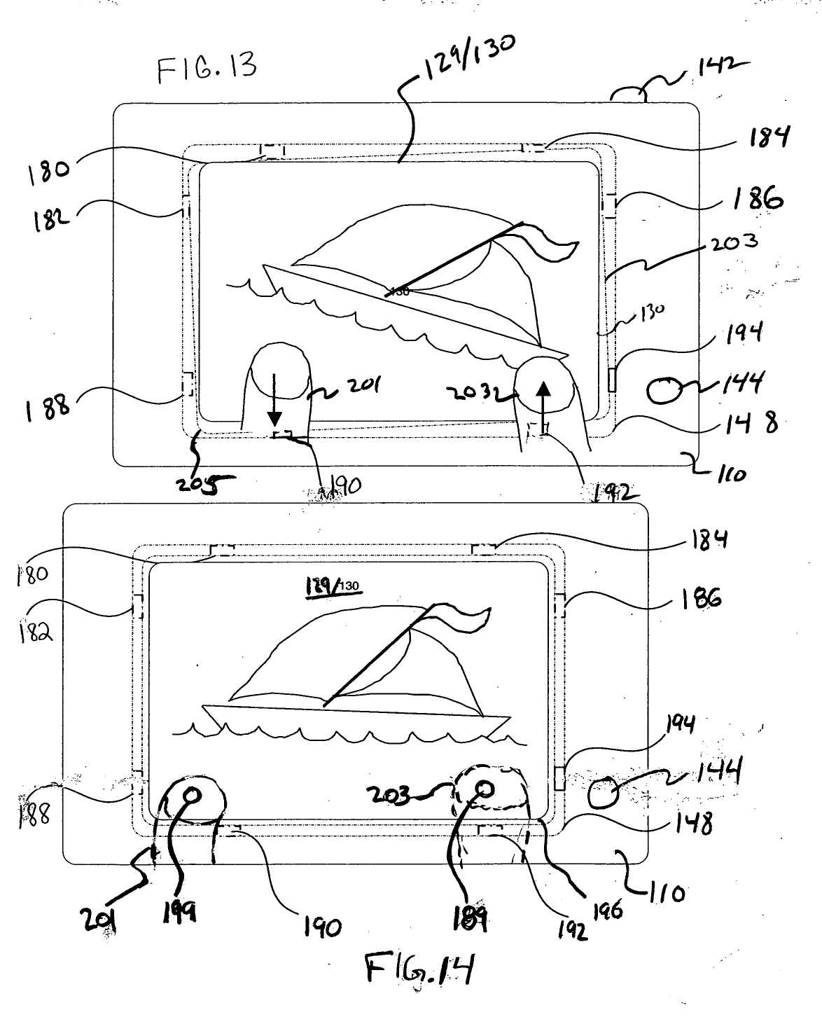

FIGS. 11 and 12 show another embodiment of this invention in which force is sensed by force sensitive elements 180, 182, 184, 186, 188, 190, 192, 194 that are placed on the periphery of display 129 between display 129 and display receiving area 148 and hidden from the users view by either an overlapping portion 196 of camera body 110, an elastomer rubber gasket, concealing structures, treatments or other covering. To select functions, display 129 is urged along plane B in an upward direction 181, downward direction 183, right direction 185, left direction 187 or diagonal direction, e.g. 191, 193, 195, 197. As this occurs, a force is applied to various ones of force sensitive elements 180, 182, 184, 186, 188, 190, 192, 194 causing these force sensitive elements to generate signals that can be sensed by controller 132. Controller 132 can use these signals to determine that a force has been applied and upon which of axes C1, C2, C3 or C4 the force has been applied. As is illustrated in FIGS. 11 and 12 in this embodiment, display 129 has a raised finger engagement area 189 to help a user to urge the display along a direction, such as upward direction 181 and to reduce the extent of finger contact with display 129 so that unnecessary fingerprints are not left on display 129.

In one application of this embodiment, display 129 can be used to enter an image rotation mode and can be rotated to intuitively indicate a desire to rotate a captured image. As is illustrated in FIGS. 13 and 14, an evaluation image represents a captured image. As can be seen from FIGS. 13 and 14, an image was captured at an angle relative to camera 102. To correct this condition, the user thumbs or fingers 201 and 203 may be placed on finger engagement areas 189 and 199 as shown and used to exert a force on display 129 as also shown. The pressure on display 129 urges display 129 to rotate slightly with such a rotated display 205 shown by phantom lines in FIG. 13. Force sensitive elements 182, 184, 186, 188, 190, 192, 194 around the periphery of display 129 sense this urging and correspondingly send signals to controller 132 causing controller 132 and/or signal processor 126 to rotate the displayed image. The extent of such rotation can be determined automatically based upon image analysis or a predetermined extent of image rotation in a direction indicated by the force(s) applied to display 129. Alternatively, the extent of rotation and the direction of rotation can be determined by an amount or duration of forces applied to display 129. Thus, a rotated image is formed as illustrated in FIG. 14. In still another embodiment, the force sensitive elements can be underneath display 129 and need to be depressed for actuation as illustrated in the preceding embodiment, while certain force sensitive elements could be allocated for sensing a force urging rotation and the user would be instructed where to press for which direction of rotation was desired.

Force sensitive elements 150, 152, 154, 156 and 182, 184, 186, 188, 190, 192, 194 can take a variety of forms. In certain embodiments, force sensitive elements 150, 152, 154, 156 and 182, 184, 186, 188, 190, 192, 194 can comprise any materials that can be resiliently expanded, compressed or otherwise shape changed in response to pressure that is applied thereto and that changes characteristics that can be detected by controller 132 when the shape is changed. For example, such as by changing capacitance, resistance, surface conductivity, or by generating a voltage or current signal.

Alternatively, force sensitive elements can be adapted to sense force with a minimum of shape change, so that a force can be applied to display 129 that causes generally insubstantial movement of display 129, but that transmits a force to the force sensitive elements that causes the force sensitive elements to generate signals that can be detected by controller 132 and used to determine the application of force. Here too, materials or structures that deflect only minor amounts in response to force, but that generate a signal that can be detected by controller 132, can be used. For example, a force sensitive element of this type can comprise a piezoelectric crystal or an arrangement of conductive plates that provide a large capacitive differential across in response to small variations in proximity such as may be generated by an application of force to parallel conductors separated by a dielectric that can be compressed by an applied force.

It will be appreciated that, in certain embodiments of the invention, it can be useful to provide a contact element 130, such as display 129, that can move within receiving area 148 wherein the extent of such movement can be sensed without necessarily maintaining contact between display 129 and the force sensing elements. Such an arrangement of force sensitive elements can be provided by mounting display 129 on a resilient linkage 146 that biases display 129 into a neutral position and resists movement of display 129 when a force is supplied thereto and by providing one or more positional sensors that are each adapted to detect when display 129 has been moved from the neutral position along at least one of two detectable axes of movement to an activation position. Such a combination is capable of detecting the application of force to display 129 in that display 129 cannot be moved without overcoming the bias force applied by resilient linkage 146. There are a variety of sensors that can be used for this purpose including optical, electrical switches or electromechanical switches. A principal advantage of this approach is that it is not necessary to provide sensors that are in and of themselves adapted to sense an application of force. Rather, in this embodiment, it is a combination of such sensors with a resilient linkage 146 that resists the application of force to enable one or more force sensitive elements that can sense an application of force display 129.

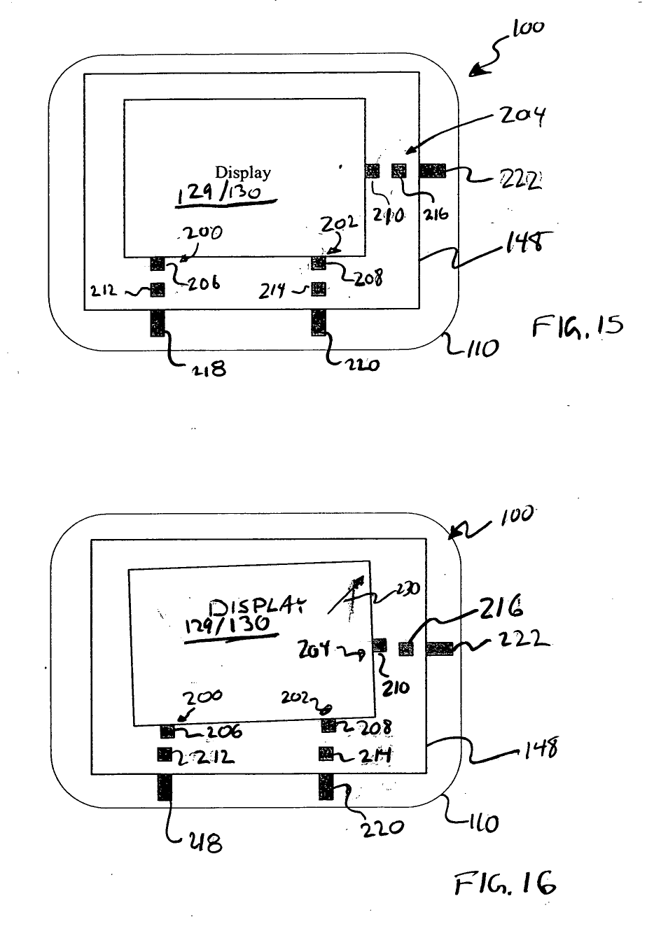

FIGS. 15 and 16 illustrate one embodiment of this type. In FIGS. 15 and 16, force sensitive elements are provided in the form of an arrangement of positional sensors 200, 202, and 204 that detect changes in the proximity of an edge or other portion of display 129 comprising a so-called “Hall Effect” sensor. The Hall Effect is a name give to an electro-magnetic phenomenon describing changes that occur in relationship between voltage and current in an electric circuit that is within a changing magnetic field. According to the Hall Effect, a voltage is generated transversely to the current flow direction in an electric conductor (the Hall voltage), if a magnetic field is applied perpendicularly to the conductor. If the intensity of the magnetic field applied perpendicularly to the conductor changes, then the voltage generated transversely to the current flow direction in the conductor will change. This change in voltage can be detected and used for a variety of positional sensing purposes.

In the embodiment illustrated FIGS. 15 and 16 each positional sensor 200, 202, and 204 comprises three elements: ferrous material areas 206, 208, and 210, respectively, Hall Effect sensors 212, 214, 216, respectively, and magnets 218, 220, and 222 respectively.

As display 129 is moved against a bias supplied by a resilient member (not shown) from an initial position shown in FIG. 15 to a force applied position as shown in FIG. 16, ferrous material areas 208 are 210 are moved away from the sensors 214 and 216 and magnets 220 and 222 respectively. This changes the intensity of a magnetic field between ferrous material areas 208 and 210 and magnets 220 and 222 respectively. This reduction in the intensity of the magnetic field is sensed by Hall Effect sensors 214 and 216 which provide signals to controller 132 of display device 100 from which controller 132 can determined that a force 230 has been applied to display 129 and can determine that the force has been applied along an axis urging separation ferrous material area 208 from magnets 220 and urging separation of ferrous material area 210 from magnets 220.

In the above described embodiments, contact element 130 has been shown in the form of a display 129 that a user of display device 100 can physically contact in order to provide user input. This advantageously provides the ability to provide a wide variety of virtual user input controls for display device 100 and to provide dynamic feedback to a user during user input actions or minimizing the cost of display device 100. However, there may be applications where it is not desirable to apply force to display 129 such as where there is a risk that such applied force can damage display 129 or that such applied force will cause display 129 to operate in an unpleasing manner. Accordingly, FIGS. 17-20 show alternative embodiments of the invention wherein virtual user input controls and dynamic feedback can be provided without requiring application force directly to display 129.

In the embodiments of FIGS. 17 and 18 a generally transparent contact element 130 is provided within display receiving area 148 between opening 131 and display 129 so that at least a part of an image presented by display 129 is viewed through contact element 130. In this embodiment force sensitive elements 150-154 are positioned between contact element 130 and display receiving area 148. Force sensitive elements 150-154 are adapted to generate a signal when a force has been applied to contact element 130. As shown in FIGS. 17 and 18 a separation S is provided between contact element 130 and display 129 allowing a movement or deflection of contact element 130 without bringing contact element 130 into contact with display 129. In this embodiment, contact elements 130 are formed from a resilient material or are otherwise shaped to resiliently resist the application of force to contact element 130 and thus also perform as a resilient linkage 146. Optionally, other structures can be used for this purpose.

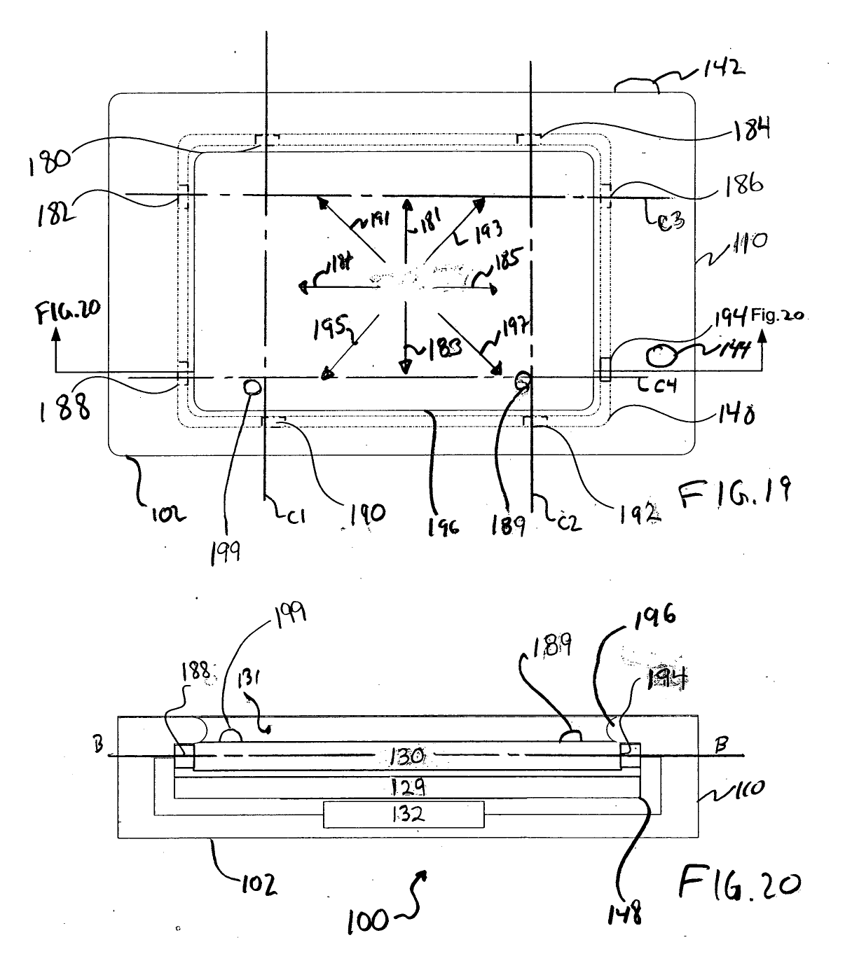

FIGS. 19 and 20 show still another embodiment of this type, which is similar in configuration and operation to the embodiment described above with reference to FIGS. 11 and 12. Here, force is sensed by force sensitive elements 180, 182, 184, 186, 188, 190, 192, 194 that are placed on the periphery of contact element 130 between contact element 130 and display receiving area 148. In this embodiment force sensitive elements 180, 182, 184, 186, 188, 190, 192, 194 are optionally hidden from the user's view by either an overlapping portion 196 of body 110, an elastomer rubber gasket, concealing structures, treatments or other covering. To select functions, contact element 130 is urged along plane B in an upward direction 181, downward direction 183, right direction 185, left direction 187 or diagonal direction, e.g. 191, 193, 195, 197. As this occurs, a force is applied to various ones of force sensitive elements 180, 182, 184, 186, 188, 190, 192, 194 causing these force sensitive elements to generate signals that can be sensed by controller 132. Controller 132 can use these signals to determine that a force has been applied and upon which of axes C1, C2, C3 or C4 the force has been applied. As is illustrated in FIGS. 19 and 20 in this embodiment, contact element 130 has a raised finger engagement area 189 to help a user to urge the display along a direction, such as upward direction 181 and to reduce the extent of finger contact with display 129 so that unnecessary fingerprints are not left on contact element 130.

Further, it will be appreciated that, any of the above described embodiments of pressure sensitive elements can be adapted to provide signals that are indicative of an amount of force applied to the display and in such embodiments, controller 132 can be adapted to use such signals for a variety of purposes. For example, in one aspect controller 132 can execute particular functions at a rate or to an extent determined by the amount of force applied to the display. For example, if a user of a display device 100 such as camera 102 wishes to review a set of images, the user can select the image review function for example from main menu 158 which can cause controller 132 to present one or more images on display 129. A user can scroll through the presented images by applying a force to display 129 along an axis. While the user does this, controller 132 can monitor the amount of force applied any given time and can adjust the rate at which images are scrolled through the display 129 in proportion to the amount of force applied. The rate can be linearly related to the amount of force applied for can be related to the amount of force applied by some other non-linear relation.

The invention has been described in detail with particular reference to certain preferred embodiments thereof, but it will be understood that variations and modifications can be effected within the spirit and scope of the invention.

### PARTS LIST

10 prior art display device
12 digital camera
13 up arrow
14 display
15 down arrow
16 housing
17 right arrow
19 left arrow
20 external controls
22 on/off button
24 menu button
26 select button
28 share button
30 navigation button
32 viewfinder
34 shutter trigger button
36 touch screen display
38 menu
40 functional area
42 functional area
44 functional area
46 functional area
100 display device
102 camera
110 body
112 top side
114 right side
116 back side
118 left side
120 bottom
122 image capture system
123 lens system
124 image sensor
125 lens driver
126 signal processor
128 display driver
129 display
130 contact element
131 opening
132 controller
134 user input system
136 sensors
138 viewfinder system
140 memory
142 capture button
144 on/off switch
145 image
146 resilient linkage
147 remote memory
148 display receiving area
149 communication module
150 force sensitive element
152 force sensitive element
154 force sensitive element
156 force sensitive element
157 fulcrum
158 main menu
160 zoom adjust function area
162 scene mode function area
164 capture mode function area
166 review mode function area
168 highlighting cursor
169 zoom control menu
170 zoom increase function area
172 zoom decrease function area
180 force sensitive elements
181 upward direction
182 force sensitive elements
183 downward direction
184 force sensitive elements
185 right direction
186 force sensitive elements
187 left direction
188 force sensitive elements
189 finger engagement area
190 force sensitive elements
191 diagonal direction
192 force sensitive elements
193 diagonal direction
194 force sensitive elements
195 diagonal direction
196 overlapping portion
197 diagonal direction
199 finger engagement area
200 positional sensor
201 thumb or fingers
202 positional sensor
203 thumb or fingers
204 positional sensor
205 rotated display
206 ferrous material area
208 ferrous material area
210 ferrous material area
212 Hall Effect sensor
214 Hall Effect sensor
216 Hall Effect sensor
218 magnet
220 magnet
222 magnet
230 force
A1 axis
A2 axis
A3 axis
A4 axis
B plane
C1 axis
C2 axis
C3 axis
C4 axis
S separation

1. A display device comprising:
a body having an opening to a display receiving area;
a display joined to the display receiving area;
a generally transparent contact element positioned between the opening and the display so that at least a part of an image presented by the display is viewed through the contact element;
at least two force sensitive elements between the contact element and the display receiving area, each force sensitive element adapted to generate a signal when a force has been applied to the contact element;
a controller to receive the signals and to determine a user input action based upon the signals received; and
wherein the force sensitive elements are adapted to detect the application of force along different axes and to generate signals that the controller can use to determine when a force has been applied to the contact element and along which of the different axes the force has been applied.

2. The display of claim 1, wherein the contact element is joined to the body by way of the force sensitive elements, and wherein the force sensitive elements are adapted to elastically deform in known relation to the extent of an amount of force applied to the contact element and to generate a signal that is indicative of the extent of such elastic deformation, said signal being detected by the controller for use in determining the user input action.

3. The display of claim 1, wherein the contact element is joined to the body by way of the force sensitive elements, and wherein at least one of the force sensitive elements is adapted to elastically deform in known relation to the extent of an amount of force applied to the contact element and to generate a signal that is indicative of the extent of such elastic deformation, said signal being detected by the controller for use in determining a user input action.

4. The display device of claim 1, wherein the contact element is joined to the body within the display receiving area for movement relative to the display receiving area and the force sensitive elements sense the application of force to the contact element by detecting movement of the contact element in response to such force.

5. The display device of claim 1, wherein the contact element is joined to the body within the display receiving area for movement relative to the receiving area and the force sensitive elements are adapted to detect a force applied to the display causing elastic deformation of any force sensitive element of not more than 2 mm.

6. The display device of claim 1, wherein the contact element is joined to the body for movement relative thereto within the display receiving area for at least one of, pivotal, slidable, and linear movement relative thereto.

7. The display device of claim 1, wherein the contact element is joined to the body for rotational movement within the display receiving area and wherein the force sensitive elements are adapted to detect an application of forces to the contact element urging said rotational movement.

8. The display device of claim 7, wherein the controller is adapted to rotate the appearance of an image presented on the display based upon the signals from the force sensitive elements.

9. The display device of claim 7, wherein at least one of the force sensitive elements comprises a binary transducer, a multi-position transducer, a continuously variable transducer, a Hall Effect sensor, a capacitive sensing transducer, a resistive sensing transducer, or a magnetic sensing transducer.

10. The display device of claim 1, wherein force sensitive elements provide signals that vary in proportion to an amount of applied force and wherein the controller is adapted to interpret the proportional variation of the signals from the force sensitive elements to determine a desired rate of executing a function or an extent to which a function is to be executed.

11. The display device of claim 1, further comprising an image capture system wherein the controller is adapted to interpret a sensed application of force to the contact element to determine at least one image capture setting to be used to capture images.

12. The display device of claim 1, wherein each force sensitive element links the contact element to the display receiving area so that each sensing element senses the application of force along at least one different axis.

13. The display device of claim 1, wherein the contact element is adapted to receive the application of forces urging rotational displacement of the contact element, and wherein the force sensitive elements are adapted to detect forces indicative of an urging of the contact element for said rotational movement, and to generate said signals that are indicative of said detected forces, and wherein said controller uses said signal to determine that a user input action requesting rotation has been made.

14. The display device of claim 1, wherein said contact element comprises said display.

15. A display device comprising:
a body having a display receiving area with a display therein;
a generally transparent contact element joined to the body for movement between a neutral position and two separate force applied positions into which the contact element can be moved within the display receiving area when a force is applied and arranged so that images presented by the display are viewed therethrough;
a plurality of force sensitive elements between the contact element and the display receiving area, each force sensitive element adapted to sense movement of the contact element into either of the force applied positions; and
a controller to determine a user input action based upon the force applied to the force sensitive elements by the contact element,
wherein movement of the contact element into one of said two separate force applied positions require movement of the display along a different axis than movement of the contact element into the other one of said two force applied positions.

16. The display device of claim 15, wherein the contact element is within the display receiving area and the display area provides for at least one of, pivotal, rotational, slidable, and linear movement relative thereto.

17. The display device of claim 15, wherein the display device further comprises a memory having image content therein and the controller is adapted to interpret sensed movement of the display relative to the body to determine a use of the image content in the memory.

18. The display device of claim 15, further comprising a communication circuit adapted to send signals for communication with an external electronic device and wherein the controller is adapted to interpret sensed application of force on the display to determine signals to be sent to the external device.

19. The display device of claim 15, further comprising a communication circuit adapted to enable wireless communication with an external electronic device and wherein the controller is adapted to interpret sensed movement of the display relative to the body to determine signals to be sent to the external device.

20. The display device of claim 15, wherein at least one of the force sensitive elements is further adapted to detect an amount of pressure applied to the display to move the display relative to the body.

21. The display device of claim 15, wherein the display is at least in part flexible.

22. A display device comprising:
a body having a display receiving area;
a display joined to the body within the display receiving area;
a plurality of force sensing elements positioned in the display receiving area in association with the display so as to sense the application of force to the display along at least two separated axes; and
a controller to determine a user input action based upon sensed application of force to the display.

23. The display device of claim 22, wherein force sensitive element provides signals from which the controller can determine a direction of force applied along an axis.

24. The display device of claim 23, wherein the at least two separated axes of comprise two parallel but separated axes and wherein the controller is adapted to determine a user input signal indicating a rotational user input when force is applied in inverse directions along the parallel axes.

25. A method for operating a display device having a contact element positioned within a display receiving area on a body, the method comprising the steps of:
sensing the application of force by the contact element against structures holding the contact element to the display receiving area at least along two different possible axes of movement; and
determining a user input action based upon a sensed application of force to the display.

26. The method of claim 25, wherein movement of the contact element is sensed without contacting the display.
